(19) United States
(12) Patent Application Publication
(10) Pub. No.: US 2025/0362395 A1
(43) Pub. Date: Nov. 27, 2025

(54) DISTANCE MEASURING APPARATUS, DISTANCE MEASURING METHOD, AND NON-TRANSITORY COMPUTER-READABLE STORAGE MEDIUM

(71) Applicant: CANON KABUSHIKI KAISHA, Tokyo (JP)

(72) Inventors: Takashi HANASAKA, Tokyo (JP); Koichi FUKUDA, Tokyo (JP); Kohei OKAMOTO, Kanagawa (JP); Shunichi WAKASHIMA, Tokyo (JP)

(21) Appl. No.: 19/295,438

(22) Filed: Aug. 8, 2025

Related U.S. Application Data
(63) Continuation of application No. PCT/JP2024/004258, filed on Feb. 8, 2024.

(30) Foreign Application Priority Data
Feb. 24, 2023 (JP) 2023-027514

(51) Int. Cl. G01S 7/487; G01S 7/481; G01S 7/4863; G01S 7/4865; G01S 17/10

(52) U.S. Cl. CPC G01S 7/4873; G01S 7/4815; G01S 7/4863; G01S 7/4866; G01S 17/10

(57) ABSTRACT

A distance measuring apparatus with light emitting elements and light receiving elements determines, as a time of flight of signal light for distance measurement, a time from light emission by any light emitting element to reception of reflected light of emitted signal light by any light receiving element. A first light receiving element receives the reflected light by a subject and environmental light. Each light receiving element includes sub-light receiving elements. The apparatus obtains a reference value from a measurement result of times of flight that are measured using detected signals of first sub-light receiving elements, and determines a time of flight of signal light for distance measurement related to the subject with use of the reference value and a measurement result of times of flight that are measured using detected signals of second sub-light receiving elements.

### CROSS-REFERENCE TO RELATED APPLICATIONS

This application is a Continuation of International Patent Application No. PCT/JP2024/004258, filed Feb. 8, 2024, which claims the benefit of Japanese Patent Application No. 2023-027514 filed on Feb. 24, 2023, both of which are hereby incorporated by reference herein in their entirety.

### BACKGROUND

### Field of the Technology

The present disclosure relates to a distance measuring apparatus, a distance measuring method, and a non-transitory computer-readable storage medium.

### Description of the Related Art

A distance measuring method based on a TOF (Time-Of-Flight) scheme is known that measures a distance to a subject by measuring the time of flight of light from emission of light to detection of reflected light. According to the TOF scheme, signal light, which is reflected light derived from a light source, is received in a state where it is mixed with external environmental light.

For this reason, Japanese Patent Laid-Open No. 2020-3446 proposes a technique to generate a histogram while a light source unit is not radiating light, find an average value of the number of counts of the histogram as a disturbance light quantity, and find the time of flight of signal light from the number of counts exceeding a threshold corresponding to this disturbance light quantity. Also, Japanese Patent Laid-Open No. 2020-134224 proposes a technique to provide a light receiving unit for noise measurement, which is different from the one for TOF measurement and receives only environmental light, and find the time of flight of signal light using a measured value of the light receiving unit for noise measurement.

However, according to the technique proposed by Japanese Patent Laid-Open No. 2020-3446, it is necessary to set the time in which the light source unit does not radiate light, that is to say, the time in which the TOF cannot be measured, and therefore there is a possibility that the frame rate for distance measurement decreases. Also, according to the technique proposed by Japanese Patent Laid-Open No. 2020-134224, it is necessary to arrange the light receiving unit for noise measurement in parallel with the light receiving unit for TOF measurement, and therefore there is a possibility that a distance measuring apparatus becomes large in size. For this reason, there is desire for improvement in the accuracy of distance measurement, that is to say, improvement in the accuracy of measurement of the time of flight of signal light, without providing the time in which the TOF cannot be measured, or without arranging the light receiving unit for noise measurement in parallel with the light receiving unit for TOF measurement.

### SUMMARY

The present disclosure has been made in view of the aforementioned issue, and realizes a technique to improve the accuracy of measurement of the time of flight of signal light for distance measurement.

In order to solve the aforementioned issues, one aspect of the present disclosure provides a distance measuring apparatus comprising: a plurality of light emitting elements; a plurality of light receiving elements; one or more processors; and a memory storing instructions which, when the instructions are executed by the one or more processors, cause the distance measuring apparatus to determine, as a time of flight of signal light for distance measurement, a time from light emission by any light emitting element among the plurality of light emitting elements to reception of reflected light of emitted signal light by any light receiving element among the plurality of light receiving elements, wherein among the plurality of light receiving elements, a first light receiving element receives the reflected light and environmental light, the reflected light being signal light which has been emitted by a first light emitting element among the plurality of light emitting elements, and which has been reflected by a subject, each light receiving element in the plurality of light receiving elements includes a plurality of sub-light receiving elements, and the instructions causing the distance measuring apparatus to determine the time of flight of signal light comprising instructions causing the distance measuring apparatus to obtain a reference value from a measurement result of times of flight that are measured using detected signals of first sub-light receiving elements that are partial sub-light receiving elements in the first light receiving element, the reference value indicating a measurement result of the environmental light that has been measured for each light receiving element, and determine a time of flight of signal light for distance measurement related to the subject with use of the reference value and a measurement result of times of flight that are measured using detected signals of second sub-light receiving elements which are included in the first light receiving element, and which are different from the first sub-light receiving elements.

Another aspect of the present disclosure provides a distance measuring method executed by a distance measuring apparatus including a plurality of light emitting elements and a plurality of light receiving elements, the method comprising determining, as a time of flight of signal light for distance measurement, a time from light emission by any light emitting element among the plurality of light emitting elements to reception of reflected light of emitted signal light by any light receiving element among the plurality of light receiving elements, wherein among the plurality of light receiving elements, a first light receiving element receives the reflected light and environmental light, the reflected light being signal light which has been emitted by a first light emitting element among the plurality of light emitting elements, and which has been reflected by a subject, each light receiving element in the plurality of light receiving elements includes a plurality of sub-light receiving elements, and the determining the time of flight of signal light comprising obtaining a reference value from a measurement result of times of flight that are measured using detected signals of first sub-light receiving elements that are partial sub-light receiving elements in the first light receiving element, the reference value indicating a measurement result of the environmental light that has been measured for each light receiving element, and determining a time of flight of signal light for distance measurement related to the subject with use of the reference value and a measurement result of times of flight that are measured using detected signals of second sub-light receiving elements which are included in the first light receiving element, and which are different from the first sub-light receiving elements.

Still another aspect of the present disclosure provides a non-transitory computer-readable storage medium storing instructions for causing a computer to execute the distance measuring method executed by a distance measuring apparatus including a plurality of light emitting elements and a plurality of light receiving elements, the method comprising determining, as a time of flight of signal light for distance measurement, a time from light emission by any light emitting element among the plurality of light emitting elements to reception of reflected light of emitted signal light by any light receiving element among the plurality of light receiving elements, wherein among the plurality of light receiving elements, a first light receiving element receives the reflected light and environmental light, the reflected light being signal light which has been emitted by a first light emitting element among the plurality of light emitting elements, and which has been reflected by a subject, each light receiving element in the plurality of light receiving elements includes a plurality of sub-light receiving elements, and the determining the time of flight of signal light comprising obtaining a reference value from a measurement result of times of flight that are measured using detected signals of first sub-light receiving elements that are partial sub-light receiving elements in the first light receiving element, the reference value indicating a measurement result of the environmental light that has been measured for each light receiving element, and determining a time of flight of signal light for distance measurement related to the subject with use of the reference value and a measurement result of times of flight that are measured using detected signals of second sub-light receiving elements which are included in the first light receiving element, and which are different from the first sub-light receiving elements.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing an exemplary functional configuration of a distance measuring apparatus according to embodiments of the present disclosure.

FIG. 2 is a diagram schematically showing a configuration of a light source unit according to a first embodiment.

FIG. 3 is a diagram schematically showing a light receiving element array according to the first embodiment.

FIG. 4 is a diagram schematically showing an appearance of projected light according to the first embodiment.

FIG. 5A is a diagram (1) for describing an appearance of projection of projected light on a subject in the first embodiment.

FIG. 5B is a diagram (2) for describing an appearance of projection of projected light on a subject in the first embodiment.

FIG. 5C is a diagram (3) for describing an appearance of projection of projected light on a subject in the first embodiment.

FIG. 5D is a diagram (4) for describing an appearance of projection of projected light on a subject in the first embodiment.

FIG. 6A is a diagram (1) for describing a histogram, and how only counts exceeding a threshold are extracted, according to the first embodiment.

FIG. 6B is a diagram (2) for describing a histogram, and how only counts exceeding a threshold are extracted, according to the first embodiment.

FIG. 7A is a diagram schematically showing sub-light receiving elements according to the first embodiment.

FIG. 7B is a diagram describing light reception by sub-light receiving elements according to the first embodiment.

FIG. 8 is a diagram for describing an appearance of reception of reflected light that has been reflected by a subject in the first embodiment.

FIG. 9 is a block diagram showing an exemplary functional configuration of a distance measuring apparatus according to a fourth embodiment.

### DESCRIPTION OF THE EMBODIMENTS

### First Embodiment

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the following description, a distance measuring apparatus that includes a light emitting element and a light receiving element will be described as an example. The present embodiment can be applied to such devices as LiDAR (Light Detection And Ranging), a digital camera, a smartphone, a game device, a tablet terminal, a medical device, a surveillance camera, and such mobile objects as a car and a robot, for example.

### <Configuration of Distance Measuring Apparatus>

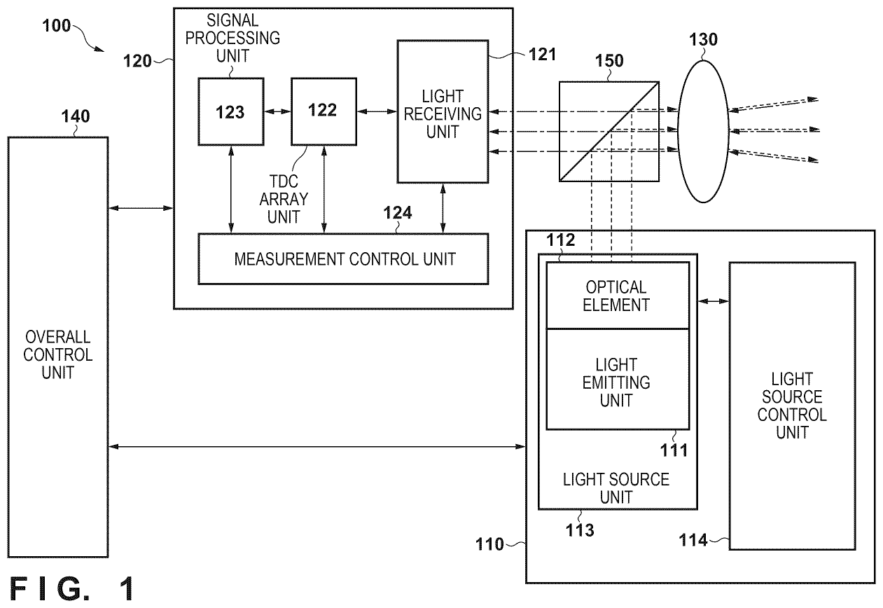

An exemplary functional configuration of a distance measuring apparatus of the present embodiment will be described with reference to FIG. 1. A distance measuring apparatus 100 includes, for example, a light projection unit 110, a measuring unit 120, an image-space telecentric lens 130, an overall control unit 140, and a beam splitter 150.

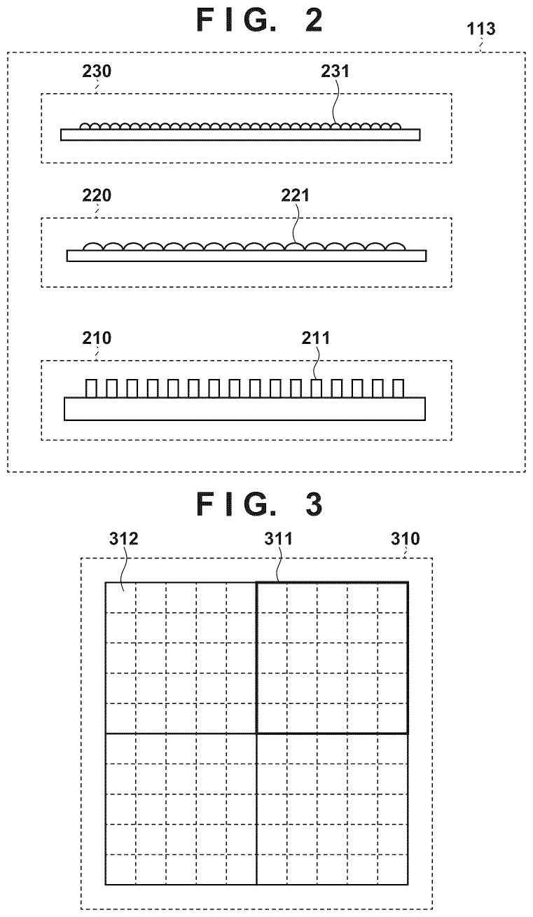

The light projection unit 110 includes, for example, a light source unit 113 including a light emitting unit 111 and an optical element 112, and a light source control unit 114. A configuration of the light source unit 113 will be described later with reference to FIG. 2. The light emitting unit 111 includes, for example, a light emitting element array 210 in which a plurality of light emitting elements 211, which will be described later, are arranged two-dimensionally. The optical element 112 in the light source unit 113 includes, for example, a collimator lens array 220 and a microlens array 230, which will be described later.

The light source control unit 114 can control driving of the light emitting elements, and drives each of the light emitting elements independently, or drives the light emitting elements for each specific area, for example. The light source control unit 114 may include a processor and a storage medium, and driving of the light emitting elements may be controlled by the processor in the light source control unit 114 executing a program stored in the storage medium. Alternatively, the light source control unit 114 may control driving of the light emitting elements in response to an instruction of the overall control unit 140.

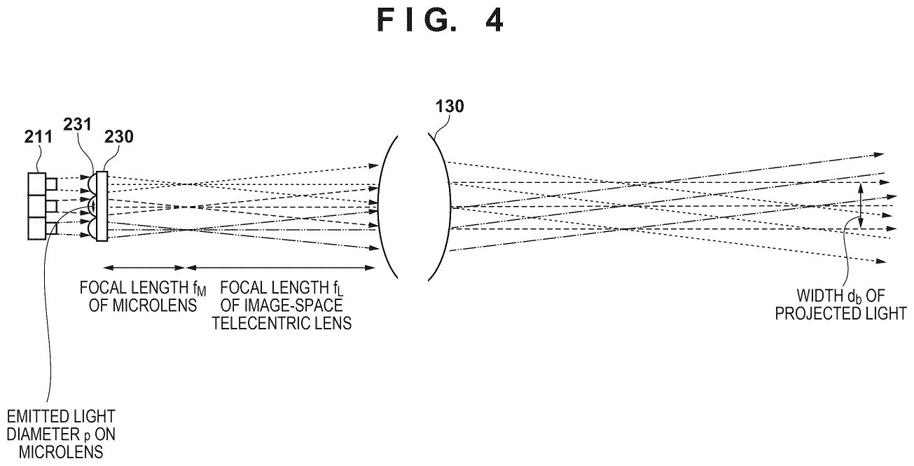

The measuring unit 120 includes, for example, a light receiving unit 121, a TDC (Time-to-Digital Convertor) array unit 122, a signal processing unit 123, and a measurement control unit 124. The light receiving unit 121 includes a light receiving element array 310, which will be described later with reference to FIG. 3. The light receiving element array 310 includes, for example, a plurality of light receiving elements that are arranged two-dimensionally, and each light receiving element includes a plurality of sub-light receiving elements.

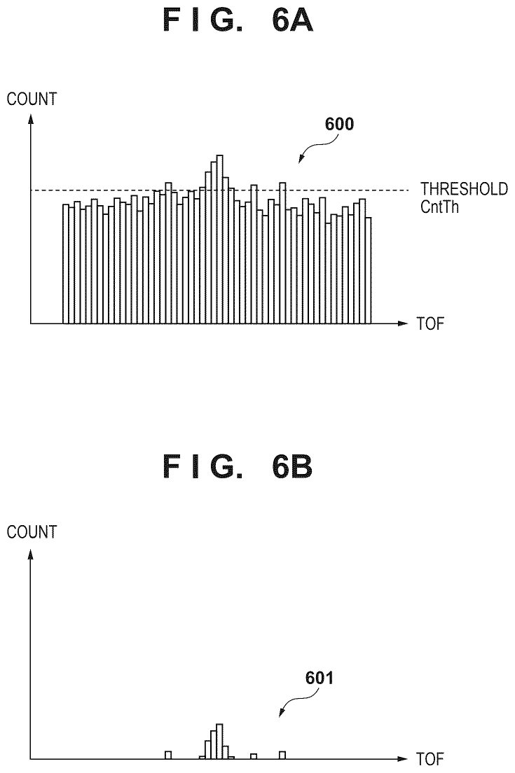

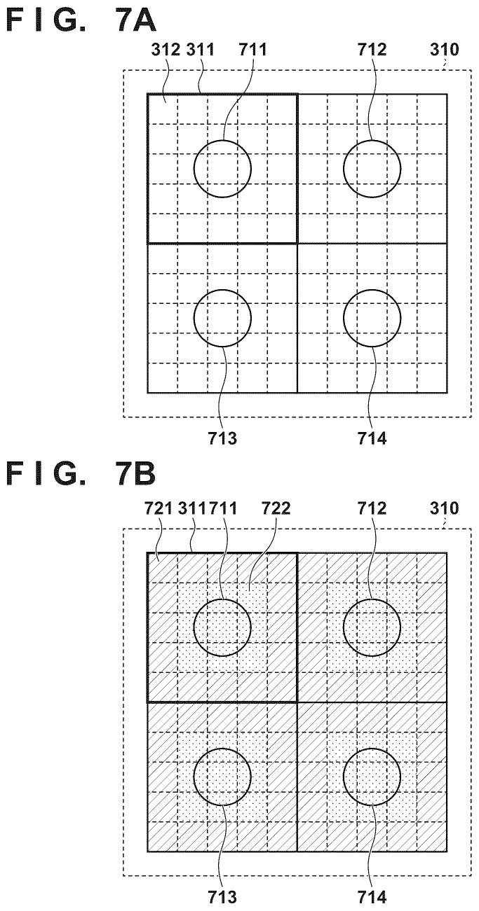

The TDC array unit 122 measures the time of flight TOF of signal light based on detected signals from the sub-light receiving elements. Based on the measurement results of the time of flight TOF measured by the TDC array unit 122, the signal processing unit 123 creates a histogram, calculates (obtains) a threshold used in removal of noise components, and extracts the time of flight of signal light, for example. Generation of the histogram and setting of the threshold performed by the TDC array unit 122 and the signal processing unit 123 will be described later with reference to FIGS. 6A-6B and FIGS. 7A-7B. The measurement control unit 124 may include a processor and a storage medium, and the operations of the light receiving unit 121, the TDC array unit 122, and the signal processing unit 123 may be controlled by the processor in the measurement control unit 124 executing a program stored in the storage medium. Furthermore, processing of the signal processing unit 123, which is described in the present embodiment, may be realized by the processor in the measurement control unit 124 executing the program, in place of the signal processing unit 123.

The overall control unit 140 includes, for example, a processor such as a CPU, a memory such as a RAM, and a storage medium such as a ROM, and controls the operations of the entirety of the distance measuring apparatus 100 by, for example, executing a program stored in this storage medium with use of the processor. Furthermore, processing by the signal processing unit 123 or the measurement control unit 124, which is described in the present embodiment, may be realized by the overall control unit 140 executing the program stored in the storage medium with use of the processor.

An overview of the operations in the distance measuring apparatus 100 will be described. First, each of the light emitting elements 211 inside the light source unit 113 emits pulsed light; as a result, the pulsed light is projected toward space via the image-space telecentric lens 130. The pulsed light emitted from different light emitting elements 211 is projected in different angles of view in space. The projected light is radiated on a subject, and a part of light reflected by the subject is received by the light receiving unit 121 via the image-space telecentric lens 130. The time from light emission by the light emitting elements 211 to light reception by the light receiving unit 121 is the time of flight TOF of signal light. The TDC array unit 122 measures this time. Note that, in general, if the measurement is performed once, it may be difficult to exclude noise light such as environmental light, and noise components attributed to dark counts, and moreover, an error in distance measurement may become large due to, for example, the influence of noise in a measurement circuit. Therefore, the distance measuring apparatus 100 repeats the measurement of the time from light emission by the light emitting unit 111 and light reception by the light receiving unit 121, generates a histogram of the measurement results in the signal processing unit 123, and performs removal of noise components, averaging of the measurement results, and the like. A distance L to the subject can be calculated with high accuracy by assigning the time of flight TOF of signal light found in the foregoing manner to the following formula (1). Here, c is a light speed.

$$[ Math . 1 ]$$

$$L = TOF \times \frac{c}{2} \qquad ( 1 )$$

### <Configuration of Light Source Unit>

Next, the light source unit 113 in the light projection unit 110 according to the present embodiment will be described with reference to FIG. 2.

The light emitting element array 210 has a configuration in which VCSELs (Vertical Cavity Surface Emitting LASERs) are arrayed as the light emitting elements 211 in the form of a two-dimensional array on a substrate. Note that in the present embodiment, although the light emitting elements 211 are not limited to the VCSELs, it is possible to use, for example, elements that can be integrated in the form of a one-dimensional or two-dimensional array, which are edge-emitting lasers, LEDs (light emitting diodes), and the like. In a case where edge-emitting lasers are used as the light emitting elements in the light emitting element array, it is possible to use, for example, a laser bar including a one-dimensional array on a substrate, or a laser bar stack that includes layers thereof and thus has a configuration of a two-dimensional light emitting element array. Also, in a case where LEDs are used as the light emitting elements, it is possible to use LEDs that are arrayed in the form of a two-dimensional array on a substrate.

In the present embodiment, for example, the wavelength of light emitted by the light emitting elements can be in the near-infrared band; in this way, the influence of environmental light can be suppressed. Note that the present embodiment does not limit the wavelength of light to the near-infrared band.

The VCSELs are created using, for example, a semiconductor process; for example, a GaAs-based semiconductor material can be used as a main material therefor in the case of a configuration that causes emission of light of the wavelength in the near-infrared band. In this case, dielectric multilayer film that forms DBR (distributed Bragg reflector) reflector mirrors composing the VCSELs can be composed of alternating and cyclical layers of two thin films formed from materials with different refractive indices (GaAs/AlGaAs). The wavelength of light to be emitted can be changed by adjusting a combination or a composition of chemical elements in a compound semiconductor.

The VCSELs forming the VCSEL array are provided with electrodes for injecting current and holes into an active layer, and arbitrary pulsed light and modulated light can be discharged by controlling the injection timing. Therefore, the light source control unit 114 can, for example, independently drive each of the VCSELs acting as the light emitting elements, and drive them for each row, column, or specific area of the VCSEL array.

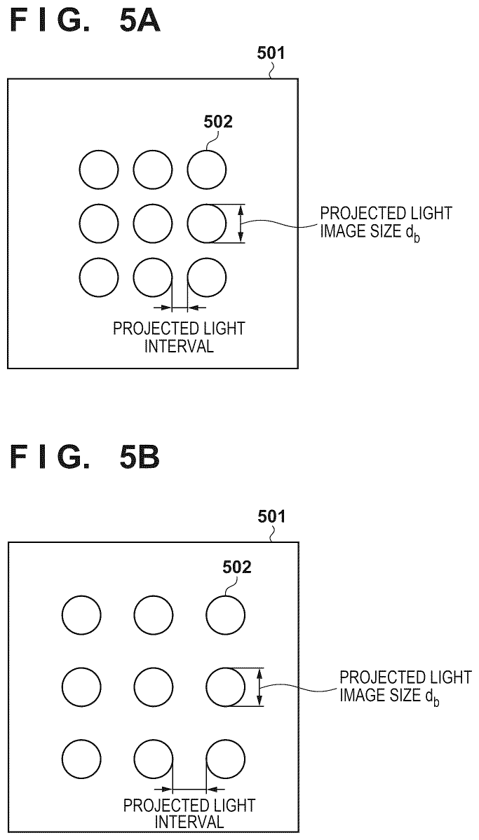

Normally, due to the diffraction phenomenon at the aperture of the VCSELs, the light discharged from the VCSELs acting as the light emitting elements 211 becomes divergent light. For this reason, the collimator lens array 220, in which collimator lenses 221 are arrayed in the form of a two-dimensional array, is arranged (between the light emitting element array 210 and a later-described microlens array 230) in order to control the divergence angle of the divergent light or change the divergent light to collimated light. In the present embodiment, the collimator lenses 221 composing the collimator lens array 220 are arranged in one-to-one correspondence with the light emitting elements 211. The light that has exited from the VCSEL array and been collimated by the collimator lens array 220 is converted into, for example, collimated light in a direction perpendicular to the VCSEL array substrate. Note that, for example, in a case where the angle of radiation from the VCSELs is small due to an aperture diameter or the like, a configuration in which the collimator lenses 221 are omitted may be used. The microlens array 230 includes, for example, a plurality of microlenses 231 that are arranged two-dimensionally. The microlenses 231 will be described later with reference to FIG. 4.

### <Exemplary Configuration of Light Receiving Elements>

Next, a configuration of the light receiving element array 310 according to the present embodiment will be described with reference to FIG. 3. The light receiving element array 310 includes, for example, a plurality of light receiving elements 311. Also, a light receiving element 311 includes a plurality of sub-light receiving elements 312. Each of the plurality of sub-light receiving elements can be independently driven. Although the example shown in FIG. 3 depicts a case where a light receiving element 311 is composed of 5×5 sub-light receiving elements 312, it may be composed of m×n sub-light receiving elements (m, n are natural numbers).

<Relationship between Light Projection and Light Reception>

Next, with reference to FIG. 4, a description is given of an appearance of a projected light image that passes through the image-space telecentric lens 130 after light emitted from the light emitting elements 211 is emitted.

The microlenses 231 composing the microlens array 230 and the image-space telecentric lens 130 compose an afocal system. In the afocal system, as an object and an image are in a conjugate relationship at infinity, a collimated light beam is incident on the microlenses 231, and a collimated light beam is injected from the image-space telecentric lens 130. That is to say, lights projected from the image-space telecentric lens 130 are projected at an angle corresponding to an image height (the positional relationship between the microlenses 231 and the image-space telecentric lens 130), and are also projected in parallel with one another. Therefore, light is projected so that, when viewed from the image-space telecentric lens 130, a width d_{b} (three-dimensionally, a thickness) of the projected light is the same width (three-dimensionally, thickness) at any distance on the subject side (independently of the distance to the subject). Note, provided that an emitted light diameter on a microlens 231 is p, a focal length of a microlens 231 is f_{M}, and a focal length of the image-space telecentric lens 130 is f_{L}, the width d_{b} of the projected light is indicated by the following formula (2). Note that in a case where p is larger than a pitch of a microlens 231, p is restricted by the pitch of the microlens 231. In a case where the width d_{b} of the projected light is larger than a pupil diameter of the image-space telecentric lens 130, the width d_{b} of the projected light is restricted by the pupil diameter.

$$[ Math . 2 ]$$

$${d}_{b} = \frac{{pf}_{L}}{{f}_{M}} \qquad ( 2 )$$

Note that although the example shown in FIG. 4 exemplarily depicts a configuration in which the collimator lenses 221 are omitted, in a case where the spread of light emitted from the light emitting elements 211 is large, the emitted light may be collimated by arranging the collimator lenses 221 between the light emitting elements 211 and the microlenses 231.

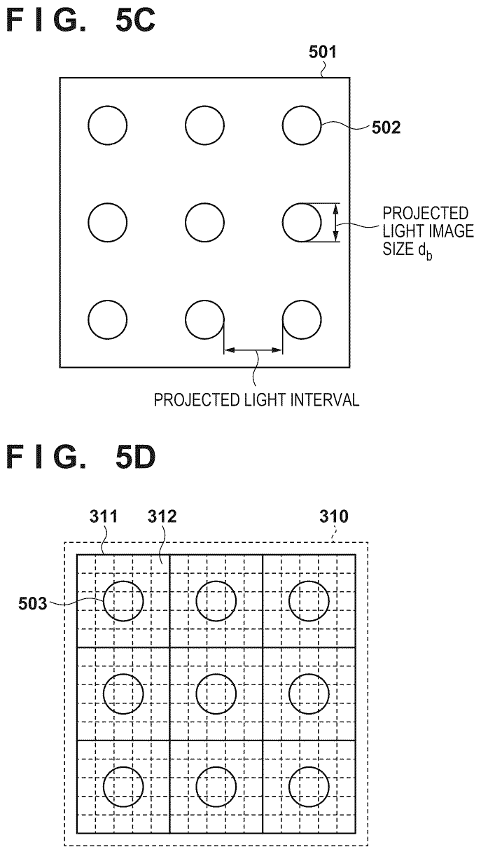

Next, an appearance of projected lights that have been described using FIG. 4 as viewed on a subject will be described with reference to FIGS. 5A-5D. Each of FIGS. 5A-5C shows an appearance of projected lights that have been projected as projected light images 502 on a subject (object) 501. A projected light image size (diameter) d_{b} shown in FIGS. 5A-5D is equal to the width d_{b} of projected light shown in FIG. 4. FIGS. 5A, 5B, and 5C are presented in ascending order of distance between the subject 501 and the image-space telecentric lens 130. FIG. 5D shows an appearance of each light receiving element 311 (composed of a plurality of sub-light receiving elements 312) in the light receiving element array 310 receiving light emitted from a corresponding, different one of the light emitting elements 211.

As shown in FIGS. 5A-5C, in a case where the light source unit 113 according to the present embodiment is used, an interval between projected lights increases with an increasing distance from the image-space telecentric lens 130, but the projected light image size do does not change. Therefore, the interval between projected lights that have passed through the image-space telecentric lens 130 and have been radiated on the subject 501 (the projected light interval) changes in accordance with a distance to the subject 501. On the other hand, the width of each of the plurality of projected lights (the projected light image size d_{b}) does not change in accordance with the distance to the subject 501. As projected light from a certain light emitting element 211 can be received only by a specific light receiving element 311 in the light receiving element array 310 as shown in FIG. 5D, the light emitting elements 211 can be in one-to-one correspondence with the light receiving elements 311. Therefore, the configuration of the present embodiment enables sequential driving that causes only a part of the plurality of light emitting elements 211 to emit light, and drives only light receiving elements corresponding to the light emitting elements 211 that have been caused to emit light among the plurality of light receiving elements 311. In this way, a plurality of light receiving elements 311 can share one TDC and the pixel size can be reduced, which is beneficial in increasing the resolution.

### <Generation of Histogram and Calculation of Threshold>

Next, generation of a time-of-flight histogram and calculation of a threshold will be described with reference to FIGS. 6A-6B. In the present embodiment, based on detected signals from the sub-light receiving elements 312, the TDC array unit 122 measures the times of flight TOF of the detected signals. Then, using the TOF, which is the measurement result, the signal processing unit 123 calculates the frequency of occurrence of the TOF (i.e., generates a histogram). In FIGS. 6A-6B, an example of the histogram generated by the signal processing unit 123 is shown as a histogram 600. Note that, as will be described later, the signal processing unit 123 generates a histogram 601 for each light receiving element 311 (using signals of the sub-light receiving elements included in the light receiving element 311), for example.

Received light that has been received by a sub-light receiving element 312 includes two lights: reflected light resulting from reflection of projected light from a light emitting element 211 on a subject (here, referred to as signal light), and reflected light resulting from reflection of external light, which is other than projected light derived from a light emitting element 211, on the subject (here, referred to as environmental light). Therefore, the histogram 600 includes the frequency of occurrence of TOF derived from signal light (here, signal light counts), and the frequency of occurrence of TOF derived from environmental light (here, environmental light counts).

The signal processing unit 123 calculates a distance to the subject from the data of the histogram 600. A method of extracting a peak of the histogram 600, or a method of fitting the vicinity of the peak of the histogram 600, can be used as a method of calculating the distance to the subject from the data of the histogram 600 (here, referred to as a subject distance calculation method).

The signal processing unit 123 calculates, for example, a state where only counts that exceed a threshold CntTh calculated from the environmental light counts have been taken out from the histogram 600. The threshold CntTh is, for example, a reference value indicating the result of measurement of environmental light (received by the light receiving elements), and taking out only the counts that exceed the threshold CntTh from the histogram 600 is equal to subtracting the threshold CntTh as an offset amount. By taking out only the counts that exceed the threshold CntTh from the histogram 600, the signal processing unit 123 can determine a time of flight of signal light with high accuracy, and calculate the distance to the subject from the determined time of flight. Here, for example, the signal processing unit 123 may calculate (obtain) the threshold CntTh in accordance with formula (3) using, for example, an average ECAve and a standard deviation ECStd of the environmental light counts.

$$CntTh = ECAve + n \times ECStd ( n \geq 0 ) \qquad ( 3 )$$

Note that although the threshold CntTh is calculated in accordance with formula (3) in the description of the present embodiment, the signal processing unit 123 may obtain a value corresponding to the average value, the standard deviation, and the like of the environmental light counts as the threshold CntTh with reference to a predefined table.

FIG. 6B shows an example of the result achieved by the signal processing unit 123 taking out only the counts that exceed the threshold CntTh among the counts in the histogram 600 shown in FIG. 6A (the histogram 601). It is apparent that the influence of the environmental light counts has been mostly removed in the histogram 601. In this way, in a case where the distance to the subject is calculated using the aforementioned subject distance calculation method, calculation can be performed with high accuracy by calculating the distance to the subject using the counts in the histogram 601, rather than the counts in the histogram 600.

### <Measurement of Environmental Light>

The average ECAve and the standard deviation ECStd of the environmental light counts described above are dependent on the reflectivity and reflective characteristics of a subject. For example, the threshold CntTh is small in a case where the threshold CntTh has been calculated from reflected light with respect to a subject with a low reflectivity. Therefore, in a case where the threshold CntTh that has been calculated with respect to a subject with a low reflectivity is applied to a histogram corresponding to a subject with a high reflectivity, many of the environmental light counts exceed the threshold CntTh, and there is a possibility of erroneous detection of a subject distance and a decrease in the accuracy of distance measurement. Conversely, the threshold CntTh is large in a case where the threshold CntTh has been calculated from reflected light with respect to a subject with a high reflectivity. Therefore, in a case where this threshold CntTh is applied to a histogram corresponding to a subject with a low reflectivity, many of the signal light counts cannot exceed the threshold CntTh, either, and there is a possibility that distance measurement cannot be performed.

For this reason, it is desirable to set the threshold CntTh at an appropriate value on a per-subject basis. Furthermore, in a case where the threshold CntTh is calculated, it is desirable to take out only the environmental light counts (the signal light counts are not included). In view of this, an example of calculation of the threshold CntTh according to the present embodiment (using the environmental light counts) will be described with reference to FIGS. 7A-7B.

In the present embodiment, the light emitting elements 211 are in one-to-one correspondence with the light receiving elements 311, as has been described with reference to FIG. 4 and FIGS. 5A-5D. Therefore, as reflected light from a certain subject is received only by a specific light receiving element 311, setting the threshold CntTh on a per-subject basis corresponds to setting the threshold CntTh for each light receiving element 311.

FIG. 7A shows an appearance of the light receiving elements 311 according to the present embodiment that are receiving reflected lights that are based on projected lights from corresponding light emitting elements 211. In the example shown in FIG. 7A, each light receiving element 311 is composed of 5×5 sub-light receiving elements 312, and 2×2 light receiving elements 311 are arranged. Furthermore, collected light images 711, 712, 713, and 714 are collected light images based on reflected lights from respective subjects that are different from one another (that may not be different depending on the subject distance).

At this time, as environmental light is collected from all angles, it is uniformly collected onto 5×5 sub-light receiving elements 312 composing the light receiving elements 311. However, signal light is collected only onto certain specific sub-light receiving elements 312 among 5×5 sub-light receiving elements 312 composing the light receiving elements 311. For example, as shown in FIG. 7B, 5×5 sub-light receiving elements 312 can be divided into partial sub-light receiving elements that receive only environmental light (sub-light receiving elements 721 for environmental light measurement), and sub-light receiving elements that receive both of environmental light and signal light (sub-light receiving elements 722 for signal light measurement). Note that the sub-light receiving elements 721 for environmental light measurement and the sub-light receiving elements 722 for signal light measurement are the same sub-light receiving elements 312. In practice, with respect to signals output from 5×5 sub-light receiving elements, the signal processing unit 123 applies different types of processing respectively to signals from the sub-light receiving elements 721 for environmental light measurement and signals from the sub-light receiving elements 722 for signal light measurement; in this way, classification of the sub-light receiving elements is realized. For example, in the present embodiment, among the sub-light receiving elements 312 composing a light receiving element 311, sub-light receiving elements arranged at positions that do not include a central portion of the light receiving element 311 can be regarded as the sub-light receiving elements 721 for environmental light measurement.

Therefore, by using only the measurement result from the sub-light receiving elements 721 for environmental light measurement, the signal processing unit 123 can calculate the threshold CntTh only from the environmental light counts (the signal light counts are not included). Furthermore, the signal processing unit 123 can calculate the threshold CntTh for each light receiving element 311 by processing signals of sub-light receiving elements for each single light receiving element 311. As a result, the threshold CntTh can be calculated on a per-subject basis (which means to calculate the threshold CntTh for each light receiving element 311 here), and a time of flight of signal light corresponding to a subject can be found with high accuracy. Then, measurement of a distance to a subject can be calculated with high accuracy.

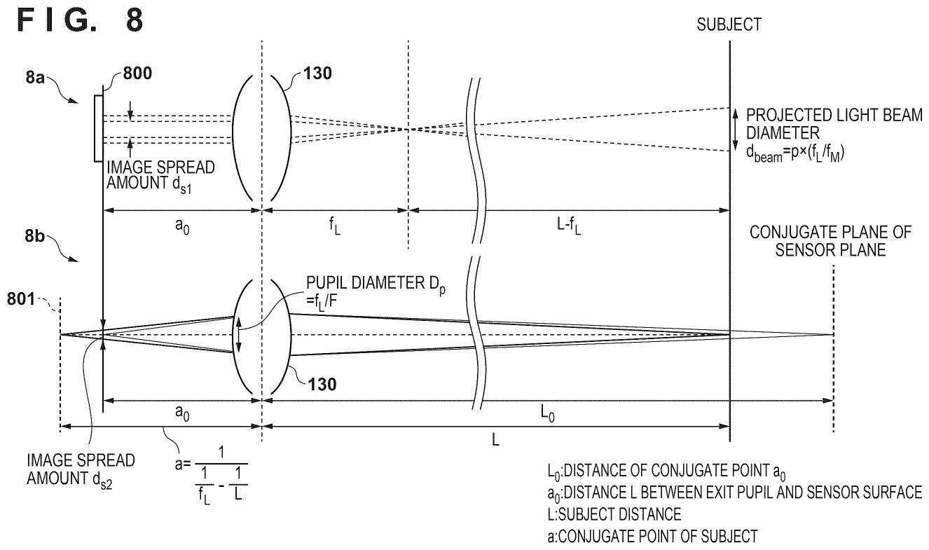

Note that the size of the collected light image 711 formed on a plane 800 of a light receiving element 311 satisfies a relationship indicated by the following formula (5), due to a received light spot diameter dₛ₁ based on a light diameter of projected light, and a received light spot diameter dₛ₂ caused by blurred focus. 8a and 8b of FIG. 8 schematically show an appearance of formation of a collected light image on a plane 800 of a light receiving element 311 after projected light has been reflected by a subject and has passed through the image-space telecentric lens 130. At this time, based on formula (4), the received light spot diameter dₛ₁ can be expressed by a focal length f_{M} of a microlens, an emitted light diameter p on the microlens, a focal length f_{L} of the image-space telecentric lens 130, and a subject distance L. Furthermore, based on formula (4), the received light spot diameter dₛ₂ caused by blurred focus is expressed using a conjugate point a₀ of the subject, a distance a from the image-space telecentric lens 130 to a plane 801 of the light receiving element 311, and F which is an F-number. Also, the size of the collected light image 711, dₛ₁+dₛ₂, needs to be smaller than a size S of the light receiving element 311.

$$[ Math . 3 ]$$

$${d}_{s 1} = \frac{{pf}_{{L}^{2}}}{{f}_{M} ( L - {f}_{L} )} {d}_{s 2} = \frac{{f}_{L}}{F} \times \vert \frac{{a}_{0} - a}{a} \vert \qquad ( 4 )$$

$$[ Math . 4 ]$$

$${d}_{s 1} + {d}_{s 2} = \frac{{pf}_{{L}^{2}}}{{f}_{M} ( L - {f}_{L} )} + \frac{{f}_{L}}{F} \times \vert \frac{{a}_{0} - a}{a} \vert < S \qquad ( 5 )$$

As described above, in the present embodiment, the threshold CntTh indicating the result of measurement of environmental light is calculated for each light receiving element, from the result of measurement by the sub-light receiving elements for environmental light measurement, which are partial sub-light receiving elements in a certain light receiving element 311. Also, a time of flight of signal light for distance measurement related to a subject is determined using the result of measurement by the sub-light receiving elements for signal light measurement, which are in the same light receiving element 311, and the calculated threshold. In this way, the threshold CntTh that has taken into consideration the reflectivity and reflective characteristics of each subject can be calculated, and a time of flight of signal light for distance measurement related to a subject can be found with high accuracy. That is to say, erroneous detection can be suppressed in distance measurement, and the accuracy of distance measurement can be improved.

### Second Embodiment

In the above-described embodiment, a plurality of sub-light receiving elements 312 composing one certain light receiving element 311 are classified into sub-light receiving elements 721 for environmental light measurement and sub-light receiving elements 722 for signal light measurement. In the present embodiment, the signal processing unit 123 can dynamically control which of the sub-light receiving elements 721 for environmental light measurement and the sub-light receiving elements 722 for signal light measurement a plurality of sub-light receiving elements 312 composing one light receiving element 311 are assigned as. Note that in the description of embodiments hereinafter, a configuration that is the same as or substantially the same as that of the first embodiment or an already-described embodiment is given the same reference numerals thereas, and a description thereof is omitted.

For example, as is comprehended from formula (4) and formula (5) described using FIG. 8, a size of a collected light image formed on a plane of a light receiving element 311 can change in accordance with a subject distance L. Specifically, the longer the subject distance, the smaller the spot diameter of the collected light image.

For this reason, the signal processing unit 123 may change which sub-light receiving elements, among a plurality of sub-light receiving elements 312 composing a light receiving element 311, are set as the sub-light receiving elements 721 for environmental light measurement and the sub-light receiving elements 722 for signal light measurement in accordance with the subject distance. That is to say, the signal processing unit 123 may cause sub-light receiving elements that are used as the sub-light receiving elements 721 for environmental light measurement among the plurality of sub-light receiving elements to vary depending on the subject distance. For example, the signal processing unit 123 may reduce the number of sub-light receiving elements set as the sub-light receiving elements 722 for signal light measurement with an increase in a subject distance of a subject image corresponding to a light receiving element 311. In this way, the roles of sub-light receiving elements can be set appropriately in harmony with a change in the magnitude of the spot diameter of a collected light image.

Furthermore, the signal processing unit 123 may cause the threshold CntTh to vary depending on the subject distance. For example, the signal processing unit 123 can increase the threshold CntTh with a decrease in the subject distance. That is to say, in a case where the subject distance is small, the signal processing unit 123 can receive sufficient signal light, and therefore can take out only counts that exceed the threshold CntTh from the histogram 600 even if the threshold CntTh is increased. Thus, by increasing the threshold CntTh, a time of flight can be determined with high accuracy, and distance measurement can be performed with high accuracy. Note that in a case where the subject distance is long, signal light decreases; therefore, in a case where the subject distance is long, the signal processing unit 123 can also reduce the threshold CntTh to make it easy to take out only counts that exceed the threshold CntTh from the histogram 600.

### Third Embodiment

A third embodiment will be described in relation to exemplary processing for a case where distance measurement is performed in a state where there is little environmental light, such as in darkness and indoors.

In a state where there is little environmental light, the sub-light receiving elements 721 for environmental light measurement can be reduced, and the sub-light receiving elements 722 for signal light measurement can be increased, among a plurality of sub-light receiving elements 312 composing a light receiving element 311. For example, the distance measuring apparatus 100 may be configured to be capable of setting a measurement mode that performs distance measurement indoors or outdoors. In this case, the signal processing unit 123 may reduce the number of the sub-light receiving elements 721 for environmental light measurement, and increase the number of the sub-light receiving elements 722 for signal light measurement, in response to setting of this measurement mode by a user. Alternatively, instead of selecting the measurement mode that performs distance measurement indoors or outdoors, the time in which there is little environmental light due to sunset and the like may be predefined and stored in the distance measuring apparatus 100, and the signal processing unit 123 may change the numbers of the sub-light receiving elements for signal measurement and for environmental light measurement in accordance with the time. Note that it is sufficient to store information that defines the time in which there is little environmental light in, for example, a ROM and the like inside the overall control unit 140.

Next, a description is given of a case where distance measurement is performed in a state where there is little environmental light and the roles of sub-light receiving elements are set. First, distance measurement is performed in a state where there is little environmental light, and outputs of a plurality of sub-light receiving elements 312 are measured. Then, in accordance with the outputs of the sub-light receiving elements 312, the sub-light receiving elements inside a light receiving element are set as the sub-light receiving elements 721 for environmental light measurement or the sub-light receiving elements 722 for signal light measurement.

In a case where distance measurement is performed in a state where there is little environmental light, sub-light receiving elements that receive signal light output high signal light counts, but sub-light receiving elements that receive environmental light output lot environmental light counts. Therefore, in a case where light receiving elements 311 receive signal light and environmental light that has a predetermined intensity or less, sub-light receiving elements that measure count values smaller than a predetermined count value can be set as sub-light receiving elements 721 for environmental light measurement. In this way, too, the roles of sub-light receiving elements can be set appropriately, and therefore a time of flight can be determined with high accuracy, and distance measurement can be performed with high accuracy.

### Fourth Embodiment

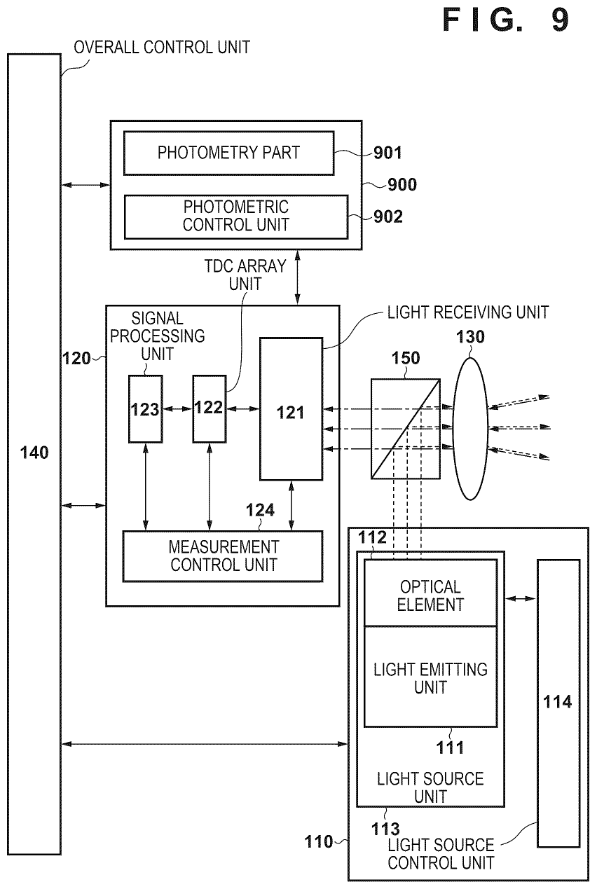

In a fourth embodiment, the distance measuring apparatus 100 includes a photometric unit 900 as shown in FIG. 9. The photometric unit 900 includes a photometric part 901 provided with a photometric sensor that measures the light intensity from outside the distance measuring apparatus 100, and a photometric control unit 902 that controls the photometric part 901. The signal processing unit 123 may change sub-light receiving elements that are used as sub-light receiving elements 721 for environmental light measurement, and sub-light receiving elements that are used as sub-light receiving elements 722 for signal light measurement, in accordance with the light intensity measured by the photometric part 901. For example, in a case where the light intensity measured by the photometric unit 900 is darker than a predefined threshold, the signal processing unit 123 may reduce the number of the sub-light receiving elements 721 for environmental light measurement, and increase the number of the sub-light receiving elements 722 for signal light measurement. In this way, too, the roles of sub-light receiving elements can be set appropriately, and therefore a time of flight can be determined with high accuracy, and distance measurement can be performed with high accuracy.

According to the present disclosure, the accuracy of measurement of the time of flight for distance measurement can be improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A distance measuring apparatus comprising:
a plurality of light emitting elements;
a plurality of light receiving elements;
one or more processors; and
a memory storing instructions which, when the instructions are executed by the one or more processors, cause the distance measuring apparatus to
determine, as a time of flight of signal light for distance measurement, a time from light emission by any light emitting element among the plurality of light emitting elements to reception of reflected light of emitted signal light by any light receiving element among the plurality of light receiving elements,
wherein
among the plurality of light receiving elements, a first light receiving element receives the reflected light and environmental light, the reflected light being signal light which has been emitted by a first light emitting element among the plurality of light emitting elements, and which has been reflected by a subject,
each light receiving element in the plurality of light receiving elements includes a plurality of sub-light receiving elements, and
the instructions causing the distance measuring apparatus to determine the time of flight of signal light comprising instructions causing the distance measuring apparatus to
obtain a reference value from a measurement result of times of flight that are measured using detected signals of first sub-light receiving elements that are partial sub- light receiving elements in the first light receiving element, the reference value indicating a measurement result of the environmental light that has been measured for each light receiving element, and
determine a time of flight of signal light for distance measurement related to the subject with use of the reference value and a measurement result of times of flight that are measured using detected signals of second sub-light receiving elements which are included in the first light receiving element, and which are different from the first sub- light receiving elements.

2. The distance measuring apparatus according to claim 1, wherein
the first sub-light receiving elements are sub-light receiving elements that do not receive the reflected light and receive the environmental light, and the second sub-light receiving elements are sub-light receiving elements that receive the reflected light and the environmental light.

3. The distance measuring apparatus according to claim 1, wherein the instructions causing the distance measuring apparatus to determine the time of flight of signal light comprising instructions causing the distance measuring apparatus to determine the time of flight of the signal light from times of flight that have been measured at a frequency exceeding the reference value by using the reference value with respect to frequencies of occurrence of times of flight that are measured using detected signals of the second sub-light receiving elements.

4. The distance measuring apparatus according to claim 1, wherein the instructions causing the distance measuring apparatus to determine the time of flight of signal light comprising instructions causing the distance measuring apparatus to determine the time of flight of the signal light for each of the light receiving elements with use of the reference value of each of the light receiving elements.

5. The distance measuring apparatus according to claim 1, wherein
each light emitting element in the plurality of light emitting elements corresponds to a different one of the plurality of light receiving elements.

6. The distance measuring apparatus according to claim 1, further comprising:
a first lens that projects signal light emitted by the plurality of light emitting elements onto a subject, and collects reflected light from the subject onto the plurality of light receiving elements; and
a microlens arranged between the plurality of light emitting elements and the first lens,
wherein the first lens and the microlens compose an afocal system.

7. The distance measuring apparatus according to claim 6, wherein
a size S of the first light receiving element, a focal length fm of the microlens, an emitted light diameter p on the microlens, a focal length fr of the first lens, a subject distance L, a conjugate point ao of the subject, a distance a from the first lens to a plane of the first light receiving element, and F that is an F-number satisfy formula (6), so that a received light spot diameter dₛ becomes smaller than the size S of the first light receiving element, the received light spot diameter dₛ being formed by reflected light which has been emitted by the first light emitting element, and which has been reflected by the subject, on the plane of the first light receiving element via the first lens:
$$[ Math . 6 ]$$
$${d}_{s} = \frac{{pf}_{{L}^{2}}}{{f}_{M} ( L - {f}_{L} )} + \frac{{f}_{L}}{F} \times \vert \frac{{a}_{0} - a}{a} \vert < S . \qquad ( 6 )$$

8. The distance measuring apparatus according to claim 1, wherein the instructions causing the distance measuring apparatus to determine the time of flight of signal light comprising instructions causing the distance measuring apparatus to increase the reference value as a subject distance decreases.

9. The distance measuring apparatus according to claim 1, wherein the instructions causing the distance measuring apparatus to determine the time of flight of signal light comprising instructions causing the distance measuring apparatus to cause sub-light receiving elements that are used as the first sub-light receiving elements among the plurality of sub-light receiving elements to vary depending on a subject distance.

10. The distance measuring apparatus according to claim 9, wherein the instructions causing the distance measuring apparatus to determine the time of flight of signal light comprising instructions causing the distance measuring apparatus to reduce the number of the first sub-light receiving elements among the plurality of sub-light receiving elements as the subject distance increases.

11. The distance measuring apparatus according to claim 1, wherein the instructions further causing the distance measuring apparatus to
set, in a case where the plurality of light receiving elements receive the reflected light and environmental light having a predetermined intensity or less, sub-light receiving elements as the first sub-light receiving elements if a frequency of occurrence of times of flight that are measured using detected signals of the sub-light receiving elements is lower than a predetermined frequency of occurrence.

12. The distance measuring apparatus according to claim 1, wherein the instructions causing the distance measuring apparatus to determine the time of flight of signal light comprising instructions causing the distance measuring apparatus to
cause the number of the first sub-light receiving elements to be different from when a first measurement mode has not been set, in response to the first measurement mode for performing distance measurement in an environment with little environmental light having been set.

13. The distance measuring apparatus according to claim 1, further comprising
a photometric sensor that measures a light intensity from outside the distance measuring apparatus,
wherein the instructions causing the distance measuring apparatus to determine the time of flight of signal light comprising instructions causing the distance measuring apparatus to change sub-light receiving elements that are used as the first sub-light receiving elements and sub-light receiving elements that are used as the second sub-light receiving elements among the plurality of sub-light receiving elements, in accordance with the measured light intensity.

14. A distance measuring method executed by a distance measuring apparatus including a plurality of light emitting elements and a plurality of light receiving elements, the method comprising
determining, as a time of flight of signal light for distance measurement, a time from light emission by any light emitting element among the plurality of light emitting elements to reception of reflected light of emitted signal light by any light receiving element among the plurality of light receiving elements,
wherein
among the plurality of light receiving elements, a first light receiving element receives the reflected light and environmental light, the reflected light being signal light which has been emitted by a first light emitting element among the plurality of light emitting elements, and which has been reflected by a subject,
each light receiving element in the plurality of light receiving elements includes a plurality of sub-light receiving elements, and
the determining the time of flight of signal light comprising
obtaining a reference value from a measurement result of times of flight that are measured using detected signals of first sub-light receiving elements that are partial sub-light receiving elements in the first light receiving element, the reference value indicating a measurement result of the environmental light that has been measured for each light receiving element, and
determining a time of flight of signal light for distance measurement related to the subject with use of the reference value and a measurement result of times of flight that are measured using detected signals of second sub-light receiving elements which are included in the first light receiving element, and which are different from the first sub-light receiving elements.

15. A non-transitory computer-readable storage medium storing instructions for causing a computer to execute the distance measuring method executed by a distance measuring apparatus including a plurality of light emitting elements and a plurality of light receiving elements, the method comprising
determining, as a time of flight of signal light for distance measurement, a time from light emission by any light emitting element among the plurality of light emitting elements to reception of reflected light of emitted signal light by any light receiving element among the plurality of light receiving elements,
wherein
among the plurality of light receiving elements, a first light receiving element receives the reflected light and environmental light, the reflected light being signal light which has been emitted by a first light emitting element among the plurality of light emitting elements, and which has been reflected by a subject,
each light receiving element in the plurality of light receiving elements includes a plurality of sub-light receiving elements, and
the determining the time of flight of signal light comprising
obtaining a reference value from a measurement result of times of flight that are measured using detected signals of first sub-light receiving elements that are partial sub-light receiving elements in the first light receiving element, the reference value indicating a measurement result of the environmental light that has been measured for each light receiving element, and
determining a time of flight of signal light for distance measurement related to the subject with use of the reference value and a measurement result of times of flight that are measured using detected signals of second sub-light receiving elements which are included in the first light receiving element, and which are different from the first sub-light receiving elements.
